(19) United States
(12) Patent Application Publication
(10) Pub. No.: US 2014/0083006 A1
(43) Pub. Date: Mar. 27, 2014

(54) FLOWERPOT HANDLE AND WHEEL ASSEMBLY

(71) Applicant: Gary L. Loser, Naples, FL (US)

(72) Inventor: Gary L. Loser, Naples, FL (US)

(21) Appl. No.: 13/627,365

(22) Filed: Sep. 26, 2012

(51) Int. Cl. A01G 9/02

(52) U.S. Cl. CPC A01G 9/02
USPC 47/66.6

(57) ABSTRACT

The present invention comprises (a) a substantially pot-shaped element, (b) an extensible or insertable handle which is also a retractable or removable handle located at or near the interior or inner side wall of said pot-shaped element, (c) a protective cover for protecting the handle or the location of such handle, and, optionally, (d) at least one rolling means or wheel assembly. Preferably, the protective cover of the present invention is a removable and replaceable cover which is placed over the extensible and retractable handle to prevent contamination of the location of the handle and its parts.

### TECHNICAL FIELD

The present invention relates to a handle for a movable container for planting herbaceous materials. Such container is generically referred to herein as a “flowerpot.” The present invention is located at or near the inner or interior wall of the flowerpot as opposed to being attached to the outer or exterior wall of the flowerpot. The present invention also provides a protective cover for protecting said handle and its parts from being exposed to herbaceous material and other sources of contamination.

More particularly, the present invention relates to a portable flowerpot having an extensible or exposed handle, i.e., the operable position, for use in moving the flowerpot to a new location, and such handle also being retractable or unexposed, i.e. the non-operable position, for when the flowerpot is in its desired location. The present invention preferably relates to flowerpot assemblies having an extensible and retractable handle which further includes at least one wheel or rolling means, and more preferably two or more retractable hidden or unexposed wheels or rolling means, so that the flowerpot assembly can be easily relocated and, when in its new desired location, the handle and, optionally, the rolling means can be retracted, hidden or removed so that the flowerpot assembly appears to have no handle or rolling means to a viewer of the flowerpot when it is in its desired location.

### BACKGROUND OF THE INVENTION

Flowerpots for the planting of herbaceous materials are well known. Flowerpots may vary in size from the smallest pots haying a volume of only a few cubic inches to large pots of several cubic feet and capable of supporting a variety of different and decorative flowers and for small or medium-size shrubs or tree. The cost of such flowerpots varies widely, with ceramic flowerpots which are hand painted being very expensive and plastic flowerpot pots being relatively inexpensive. Similarly, the weights of such flowerpots can also vary widely.

It is well known that flowerpots may be made or formed from any suitable material, such as fired terra cotta, ceramics, metals, plastics, or other acceptable materials. Suitable plastic materials can be readily injection molded or blow molded to form various designs of flowerpots. Flowerpots can be utilitarian when used in a nursery for the temporary raising of stock for subsequent transplantation into the ground, or they can be permanent containers for decorative plants in homes, yards or commercial locations. Quite often, a homeowner or business owner desires to relocate the flowerpots containing the decorative plants.

Typically, flowerpots are provided with a curved rim extending around the upper opening. Very often such rim is reinforced and is grasped by a person wanting to transport the flowerpot to a different location. Such transport is readily accomplished by most persons when a flowerpot loaded with herbaceous material weighs only a few pounds. However, large flowerpots when loaded may weigh as much as 50 to 100 pounds or more and are not readily carried or transported to a new or different location. Even lighter loaded flowerpots may not be easily transported by older or disabled persons.

U.S. Pat. No. 7,908,794 addresses the relocation of flowerpots by providing a wheeled flowerpot assembly including at least one axle and rolling means near the lower region of a pot-shaped element. The axle is located from the bottom of the flowerpot by a distance greater than the radius of the wheels such that the wheels are not in contact with the surface on which the assembly rests. Initial tipping of the flowerpot assembly brings the wheels into contact with the surface on which the assembly rests, and further tipping frees the bottom of the pot from contact with the surface on which the assembly rests. A detachable vertical handle is attached to its outside or exterior wall above the axle to facilitate tipping and moving. The flowerpot assembly may then be readily moved to a new location. U.S. Pat. No. 7,908,794 is hereby incorporated by reference in its entirety into the present patent application.

What is needed in the art is a simple and relatively inexpensive unexposed handle which can be exposed when an individual desires to move the flowerpot to a new desired location, preferably by rolling. The handle and, optionally, the rolling means can be retracted or removed from its extended operative position so that the flowerpot assembly appears to have no handle or rolling means to a viewer of the flowerpot.

It is a principal object of the present invention to provide flowerpots where a viewer will not notice that the flowerpot has an interior location for a handle which can be used to pull or push the flowerpot to a new desired location, but once in place the flowerpot looks like any flowerpot not having a location for a hidden handle and, optionally, hidden wheels.

It is another object of the present invention to provide a simple and inexpensive handle means for making a flowerpot readily portable by a single person by rolling.

It is a further object of the present invention to prevent injury to a person moving a flowerpot.

### SUMMARY OF THE INVENTION

The present invention comprises (a) a pot-shaped element, (b) an extensible or an insertable handle which is also a retractable or removable handle, respectively, located at or near the interior or inner side wall of the pot-shaped element, (c) a protective cover for protecting the location of such handle, and, optionally, (d) at least one wheel or rolling means assembly.

Preferably, the protective cover of the present invention is a removable and replaceable cover, most preferably, a durable plastic cover, which is placed over the extensible and retractable handle and its parts or mechanism to prevent contamination of the location of the handle and its parts. The protective cover is removable so that the handle and its mechanism and/or parts can be repaired or replaced should it break or become contaminated or otherwise become inoperable. Optionally, the protective cover includes a snap-on cap for the top of the protective cover to help keep contaminants from entering the protected area.

### BRIEF DESCRIPTION OF THE DRAWING

FIG. 1 is prior art showing an elevational cross-sectional view of a wheeled flowerpot assembly having a handle located on the exterior of its side wall.

FIG. 2 is an elevational cross-sectional view of a wheeled flowerpot assembly having a handle located on the interior of its side wall in accordance with the present invention.

FIG. 3 is a partial view of a preferred handle embodiment with the handle retracted inside the flowerpot.

FIG. 4 is a partial view of a preferred handle embodiment with the handle extended for movement of the flowerpot to a new location.

### DESCRIPTION OF PREFERRED EMBODIMENTS

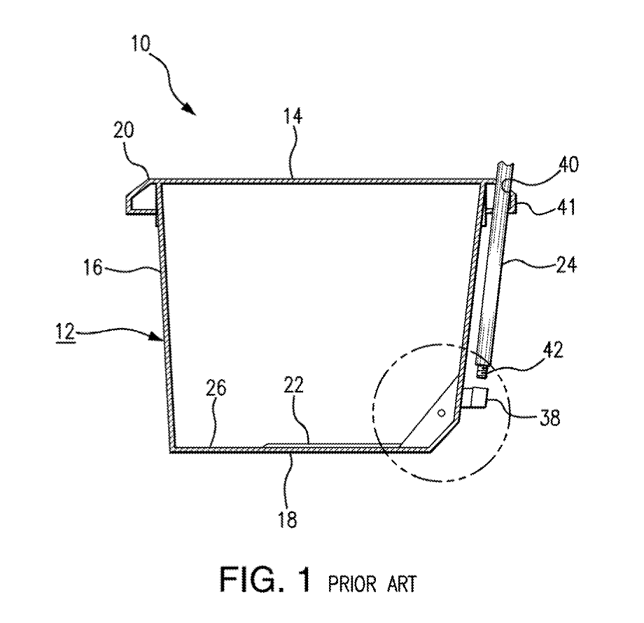

FIG. 1 illustrates the closest prior art, which is disclosed in U.S. Pat. No. 7,908,794 entitled “Wheeled Flowerpot Assembly.” Such flowerpot assembly (10) is shown as having a handle (24) affixed to the exterior of its side wall (16), but such prior art does not show or suggest having a handle located at or near the interior of its side wall (16). Such flowerpot assembly (10) prior art also does not disclose or suggest a protective cover to protect its handle or the location of its handle from contaminants such as planting soil. Also, the '794 patent does not disclose or suggest an extensible and retractable handle which is located at or near the interior surface of the side wall (16) as disclosed in preferred embodiments of the present invention. As disclosed in U.S. Pat. No. 7,908,794, which is incorporated into the present patent application in its entirety, the '794 patent also shows in its various Figures wheels and wheel assemblies which can be used in the present invention.

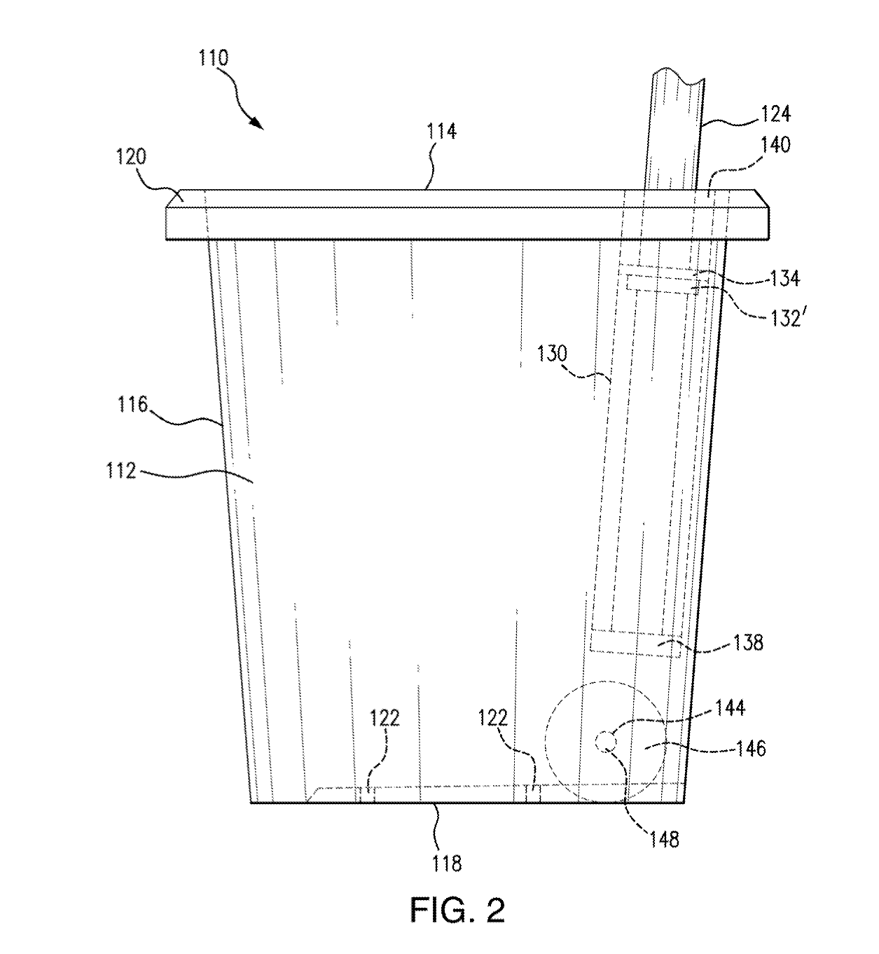

Referring to FIG. 2, a flowerpot assembly (110) in accordance with the present invention preferably comprises a pot-shaped element (112) having an upper opening (114), generally an upright arcuate side or wall (116) forming a somewhat cylindrically-shaped container, i.e., said wall (116) having an interior or inner surface and an exterior or outer surface, and a bottom (118) for holding the planting medium and one or more living or artificial plants. Preferably, said side or wall (116) tapers inward from a rim (120) surrounding opening (114) to the bottom (118). Pot-shaped element wall (116) can form a cylindrical pot-shaped element (112) or pot-shaped element (112) can be comprised of independent walls (116) to form, for example, a pot-shaped cubic container having four vertical walls and a bottom (118). The shape of element (112) may, of course, be of any suitable shape.

Rim (120) is formed in an outward roll to provide structural rigidity to pot-shaped element (112) at upper opening (114), and also to provide means for lifting pot-shaped element (112) when empty, or tipping element (112) when full. Bottom (118) preferably includes an elevated portion (122) having drain holes therein to promote water drainage through such plurality of drain holes.

Pot-shaped element (112) may be made or formed out of any suitable material, including, but not limited to, fired terra cotta, ceramics, metals or plastics, which plastics can be readily injection molded or blow molded. Similarly, extensible and retractable handle (24) and its parts or mechanism for operation can be made of any suitable material, such as, for example, metal, plastic, wood, or a combination of such materials, such as metal and plastic. Handle (124) may be of any convenient suitable shape, but preferably is a rod-shaped structure.

As shown in FIG. 1, pot-shaped element (12) of the '794 patent is provided with a receptacle or socket (38) located on the exterior or outer surface of wall (16) for receiving handle (24). However, as shown in FIG. 2, it is important with regard to the present invention that said handle (124) be located at or near the interior or inner wall (116) rather than the exterior of said wall (116) so that said handle (124) cannot be seen by a viewer when it is removed or retracted into the flowerpot (110) of the present invention.

With regard to the present invention, the terms “retracted” or “retractable” also means “removable” and “re-attachable” as described in the '794 patent. Thus, pot-shaped element (112) can be provided with a receptacle or socket (138) at or near the inner portion of wall (116) and, preferably, located in the lower half of said element (112), more preferably, in the lower third of said element (112), and, most preferably, in the lower quarter of said element (112), for receiving said handle (124) to facilitate relocating flowerpot (110). Thus, it should be clear that said handle (124) may be removable and re-attachable rather than extensible and retractable as provided in a more preferred embodiment of the present invention.

In a removable and re-attachable embodiment of the present invention, there is also preferably provided an easy locking mechanism with regard to the socket (138) to insure that handle (124) is securely attached thereto. In one such locking embodiment, pot-shaped element (112) is preferably provided with a threaded socket (138) attached to or near the inner wall (116) for receiving a threaded handle (124). The lower end of handle (124) is receivable in the socket and both may be mutually threaded to securely retail handle (124) in said socket during relocation maneuvers. In such embodiment of the present invention, any convenient rod-shaped object, for example, a broomstick or mop handle, can function as handle (124). When flowerpot (110) is relocated to its desired new position, handle (124) may be removed or retracted so that a viewer would not see handle (124) in its new location. Other appropriate removable and re-attachable locking handle means (124) will be obvious to one skilled in the art.

As can be seen in FIG. 2, a method for using such removable and re-attachable handle (124) in accordance with this embodiment, shows that a detachable handle (124) is inserted through opening (140) into socket (138), both of which are located at or near the interior surface of wall (116). Handle (124) they is depressed by an operator (not shown) such that flowerpot assembly (110) is pivoted through an angle such that the wheel(s) (146) become engaged with the surface upon which flowerpot (110) rests, and that such pot-shaped element (112) is raised from contract with the surface. In the resulting pivoted position, the flowerpot assembly (110) is ready for relocation by being rolled along the surface on wheel(s) or wheel means (146). When relocation is complete, the pivoting process is reversed and handle (124) may be detached and removed.

An embodiment having an extensible and retractable handle (124) which has a locking mechanism, comprises a handle having an inner rod which, when retracted, is retained inside of an outer rod and is hidden from view; i.e. in its non-operable position. When said handle (124) is extended to its operable position for moving the flowerpot (110) to a new location, the inner rod is pulled away from, or out of the outer rod to the desired length, and then it is turned or twisted, for example, counterclockwise, so that the inner rod and the outer rod are securely bound together. Of course, such inner and outer rods are appropriately threaded so that by counterclockwise turning the inner and outer rods are threaded together. After relocation of the flowerpot (110), the extended handle is turned clockwise so that the inner rod can be pushed down into the outer rod. When that is done, the handle (124) again becomes hidden within the protective cover. Preferably, such rod mechanisms are made of metal, however, any suitable material may be used. Such mechanisms are well known in the relevant art.

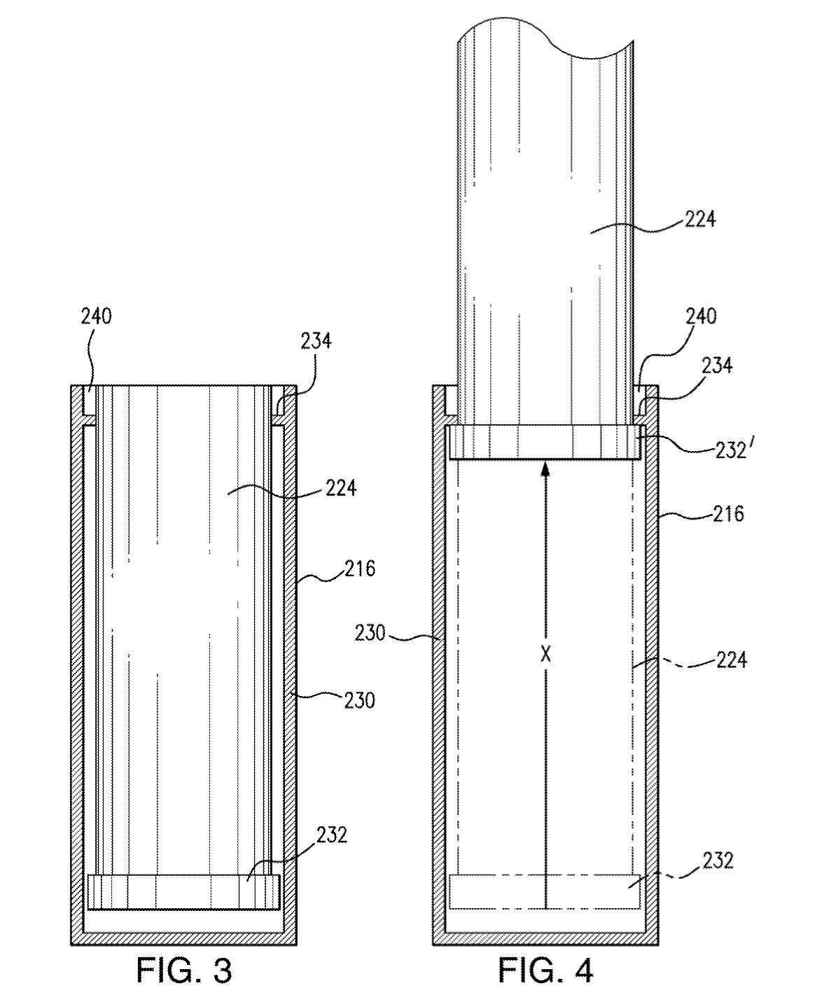

A more preferred embodiment of a rod-like handle means (224) operates as illustrated in FIG. 3 and FIG. 4. In such embodiment, there is a movable solid annular ring (232) permanently attached to handle (224) which can be moved with handle (224) when handle (224) is extended or retracted. Such movable ring can, for example, be located so that it is close to the column cover (230) in which handle (224) is extended or retracted. Annular ring (232) can be made of any suitable material such as metal, wood, plastic and the like. The preferred material for the annual ring (232 is a metal, and preferably is noncorrosive, such as stainless steel.

At a distance “x” above such annular ring (232) is located a permanent non-movable solid annular stopper ring (234) so that when the handle (224) is extended by a distance “x” movable annular ring (232) attached to handle (224) is stopped by immovable stopper ring (234) at location distance “x” from its original location (232′). Thus, handle (224) can be extended, for example, distance “x” when it is desired to move the flowerpot to a new location as long as there is at least one such annular ring (232) and stopper ring (234) in place. However it is possible to implement more than one such annular ring (232) and stopper ring (234) arrangement to provide additional strength to the handle when it is in the extended position so that the flowerpot can be moved. Having two or more is preferred for larger, heavier flowerpots. Stopper ring (234) preferably is permanently attached to protective cover (230), however it is contemplated that stopper ring (234) need not be permanently attached to said protective cover (230).

Such an arrangement will provide adequate protection to the handle (224) so that it can be extended and retracted whenever the flowerpot is to be moved to a new location. As with annular ring (232), the stopper ring (234) can be made of any suitable material such as metal, wood, plastic and the like, and preferably, such stopper ring (234) is made of metal, most preferably it is noncorrosive, such as stainless steel. An advantage of such extendable and retractable handles is that the handle (224) will not be lost when not in use whereas the removable and re-attachable arrangements may lose the required handle when it is stored, for example in the owner's garage. The method for using such extensible and retractable embodiment is essentially the same as described above for the removable and re-attachable embodiment of the present invention.

It is further contemplated, for example, that a threaded socket and handle embodiment can be combined with a different locking mechanism embodiment. Thus, the equivalent of a threaded broomstick, preferably metal, is threaded into socket (138). However, such broomstick also comprises a hollow outer rod and an inner rod contained therein which can be extended and turned counterclockwise to secure the extended handle to its operative position, or turn the extended handle clockwise to retract the handle to its non-operative position so that it is hidden to an observer. Such an embodiment provides extra strength and support to the handle (124) for moving flowerpot assembly (110). Such additional strength and support is particularly important as the weight of the flowerpot assembly (110) increases.

Handle (124) also can operate in the same manner as an extensible and retractable handle means employed in a luggage case, for example, as set forth in U.S. Pat. No. 4,575,109, which is hereby incorporated by reference in its entirety into the present patent application. Such handles used on luggage are preferred for use only on more expensive flowerpots so that the cost of such handles can be more easily incorporated into the cost of the flowerpot. A particular advantage of the '109 patent is that it includes retractable rolling means and a retractable handle which is pivotable between a retracted, non-operative position to an extended, operative position.

Movement of the handle between its retracted and extended positions moves the wheels between their corresponding retracted and extended positions. The mechanism for accomplishing the above extension and retraction includes a cam or motion transfer link associated with one end of the handle so that as the handle is pivotally moved from the retracted to an extended position, the wheels are moved in a similar fashion. The mechanism also includes a support leg member which is extended and retracted in conjunction with the wheel movement so that when the wheels are extended and in an operable position, the leg member is also in an extended position, thus permitting the flowerpot to be supported in a fully upright position.

As illustrated in FIG. 2, a protective cover (130) for protecting the user's ability to insert or reinsert said handle (124) into the socket (138), or for protecting the extensible and retractable handle (124) and its parts or mechanism is an essential part of the present invention. Because said handle (124) would be exposed to the herbaceous material contained in said flowerpot (110), it is essential that the handle location be protected from contamination.

Preferably, the protective cover is primarily columnar in shape and made of a suitable and durable, yet somewhat flexible, plastic material which can be removed and subsequently reinserted or replaced into its protective position. Such protective cover should be suitably located, preferably within approximately one inch of handle (124), and such protective cover preferably can be removed from and replaced to its protective position.

In a preferred embodiment, such protective cover having a primarily columnar shape is formed as part of its manufacturing process. In one such preferable embodiment, the upper portion of such protective cover is made primarily of ceramic or fired terra cotta material with the lower portion being a removable and re-attachable plastic protective cover below said ceramic or fired terra cotta columnar cover. Regardless of how such cover is formed, it is desirable that the cover can have one or more holes therein for draining water as the water percolates downward in the flowerpot.

It is preferred that the protective cover have a removable and re-attachable cap for the top surface of the protective cover to insure that a minimal amount of contaminants will enter into the protective column. Such cap may be part of said handle (124) or it may be an independent component of said protective cover. Again, it is preferred that such protective cover be columnar for receiving said cap. Preferably, such cap will be a “snap-on” plastic cap. Having a cap to place on the top surface of the protective cover also will allow the protective column to be hidden a small distance wider the soil so that a viewer of the flowerpot will be less likely see the location of the handle and its protective cover. Of course, such snap-on cap is not ordinarily used during transport of the flowerpot to its new location.

The present invention optionally, and preferably, includes one or more wheels or a similar suitable rolling means. The rolling means or wheels as well as the axle may also be constructed of any suitable material, preferable a metal or a hard, durable plastic material. For example, the flowerpot (110) of the present invention may have “outboard” wheels as disclosed in U.S. Pat. No. 7,908,794, but preferably the rolling means or wheels are disposed in a recessed portion or cavity of said pot-shaped element (112) where hidden, extensible and retractable wheels are provided to the present invention. Preferably, such recessed portion also includes protrusions from the new bottom of pot-shaped element (112) when a cavity is provided, which provides additional support or strength to the flowerpot of the present invention.

In one rolling means embodiment of the '794 patent, a continuous rod-shaped axle is disposed in a reinforced region through a bore extending therefrom at each end. First and second wheels are mounted in known fashion on the extending ends of the axle and secured thereupon by fastener means which preferable are removable, for example, frictional caps as are known in the prior art.

In a second rolling means embodiment the pot-shaped element is provided with first and second flanges generally in lieu of said reinforcing region and having individual bores therethrough for receiving first and second stub-axles which may be secured thereto by nuts. Wheels are mounted to axles as in the first embodiment.

In both of these above embodiments it is preferable that the axle be positioned with respect to the bottom of the pot-shaped element such that a load is not imposed on the wheels when the assembly is in the non-relocation mode to prevent the wheels developing flats spots, thus the distance from the axle axis to the bottom of the pot is preferably slightly greater than the radius of the wheels. However, this is not a requirement and all configurations of an integral wheel assembly are intended to be fully comprehended for use with the present invention.

In a third rolling means embodiment, a single roller may be substituted for wheels. Such roller is conveniently disposed between flanges on a single axle capped with fastener means outboard of the flanges. Such embodiment requires formation of a roller well in pot-shaped element analogous to wheel wells.

All variations on structures of flowerpots discussed immediately hereinabove feature axles and wheels that are permanently mounted to the pot-shaped element. However, flowerpot assemblies wherein the axles and wheels may be installed for relocation of the assembly and may be removed following relocation are fully contemplated.

Also considered to be within the scope of the present invention are flowerpots having a removable wheeled truck, for example, as described in U.S. Pat. No. 7,908,794.

While the present invention has been described by reference to specific embodiments, it should be understood that numerous changes may be made within the spirit and scope of the inventive concepts described. Accordingly, it is intended that the present invention will not be limited to the described embodiments, but will have full scope defined by the language of the following claims.

What is claimed is:

1. A flowerpot assembly, comprising:
(a) a pot-shaped element comprising (i) at least one wall having an inner side and an outer side, (ii) a bottom, and (iii) an upper opening,
(b) a handle located at or near the inner side of the wall of the pot-shaped element, and
(c) a protective cover for the handle.

2. The flowerpot of claim 1 wherein the handle is extensible and retractable.

3. The flowerpot of claim 1 wherein the handle is removable and re-attachable.

4. The flowerpot of claim 3 wherein the handle is inserted into a receptacle located at or near the inner side of the wall of the pot-shaped element.

5. The flowerpot of claim 4 wherein the handle is threaded, and the threaded handle is threaded into a threaded socket.

6. The flowerpot of claim 5 wherein the threaded socket is located in the lower half of the pot-shaped element.

7. The flowerpot of claim 5 wherein the threaded socket is located in the lowest third of the pot-shaped element.

8. The flowerpot of claim 5 wherein the threaded socket is located in the lowest quarter of the pot-shaped element.

9. The flowerpot of claim 2 wherein the handle has a locking mechanism.

10. The flowerpot of claim 9 wherein the locking mechanism comprises a handle having an inner rod which is capable of being retracted into an outer rod, and which rods when extended can be turned so as to secure the attachment lithe inner rod and the outer rod.

11. The flowerpot of claim 2 wherein the handle comprises a movable annular ring permanently attached to the handle and above the movable annular ring is an immovable stopper ring so that when the handle is extended to an operable position its extension is restricted by the immovable stopper ring.

12. The flowerpot of claim 11 wherein there are two or more movable and immovable rings to limit the extension of the handle.

13. The flowerpot of claim 1 wherein the protective cover is removable and re-attachable.

14. The flowerpot of claim 1 wherein the protective cover is primarily columnar in shape.

15. The flowerpot of claim 1 wherein the protective cover is a durable plastic material.

16. The flowerpot of claim 15 wherein the protective cover is a flexible plastic material.

17. The flowerpot of claim 1 wherein the protective cover is made of (a) a ceramic or fired terra cotta portion nearer to the upper opening arid (b) a plastic portion nearer to the bottom.

18. The flowerpot of claim 1 further comprising a cap located an the top surface of the protective cover when the handle is in its non-operative position.

19. The flowerpot of claim 18 wherein the cap is a snap-on plastic cap.

20. The flowerpot assembly of claim 1, further comprising at least one wheel or rolling means assembly including at least one axle means mounted on said pot-shaped element and at least one rotatable element disposed on said axle means.
